(19) United States
(12) Patent Application Publication
(10) Pub. No.: US 2011/0035337 A1
(43) Pub. Date: Feb. 10, 2011

(54) UNMANNED MAIL ACCEPTING METHOD AND DEVICE AND DATA MANAGING DEVICE

(75) Inventors: Yong Hoon Choi, Daejeon (KR); Heongyu Lee, Cheongju-si (KR); Hoon Jung, Daejeon (KR); Jong Heung Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/623,840

(22) Filed: Nov. 23, 2009

(30) Foreign Application Priority Data
Aug. 10, 2009 (KR) 10-2009-0073478

(51) Int. Cl. G06Q 50/00; G06F 17/00; G06Q 30/00

(52) U.S. Cl. 705/406; 235/375; 705/407; 705/408

(57) ABSTRACT

An unmanned mail accepting device verifies ordinary and registered mail to be provided by a client, settles postage for the verified ordinary and registered mail, and displays electronic postmark information on the mail.

### CROSS-REFERENCE TO RELATED APPLICATION

This application claims priority to and the benefit of Korean Patent Application No. 10-2009-0073478 filed in the Korean Intellectual Property Office on Aug. 10, 2009, the entire contents of which are incorporated herein by reference.

### BACKGROUND OF THE INVENTION

(a) Field of the Invention

The present invention relates to an unmanned mail accepting method and device, and a data managing device.

(b) Description of the Related Art

In general, a post office and a mail center accept a large amount of mail requested by a large company or a direct mail (DM) service provider without postmarks at an acceptance window. Further, postage of a large amount of mail is computed by using a method of sampling, measuring, and converting letters. The method of sampling, measuring, and converting letters represents a method for selecting random mail as samples from among a large amount of mail, calculating rates, and multiplying the rates by the number of all pieces of mail, thereby acquiring the charges, and the same method can generate an erroneous number of pieces of mail depending on variations of conditions such as temperature and humidity. Resultantly, it is required in some cases to correct the postage. However, a large amount of mail without postmarks cannot be additionally charged when the postage is to be corrected.

Further, since it is difficult to catch advance information such as a quantity of a large amount of accepted mail and acceptance time, when a client has a large amount mail accepted, particularly, a large amount of registered mail just before business hours end, a long time is required to input acceptance information such as addresser and addressee information, and hence the load generated by processing mail is increased and other clients have to wait longer.

To solve this problem, an unmanned postal window system is installed at the post office or an area with a great floating population, and it receives ordinary and registered mail. However, the unmanned postal window system does not provide an electronic postmark function, and the client inconveniently has to acquire certificate stamps from the unmanned postal window system and put each of them on the mail.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an unmanned mail accepting method and device for easily and quickly processing calculation and acceptance of charges for a large amount of mail, and a data managing device.

An exemplary embodiment of the present invention provides an unmanned mail accepting device including: a weight measurer for measuring at least one of weight, standard, and identifier information of mail to be accepted; a verifier for verifying the mail to be accepted by using a measurement result of the measurer; a rate calculator for calculate postage of the verified mail according to the weight of the mail to be accepted; a settler for settling the postage through communication with a postage settling device; and an electronic postmark unit for displaying electronic postmark information on the mail when the postage is settled.

Another embodiment of the present invention provides a data managing device connected to an unmanned mail accepting device through a network, including: a member manager for managing client information including a client identifier; an ordinary mail manager for providing a mail identifier for ordinary mail provided by the client to the unmanned mail accepting device, receiving electronic postmark information that is displayed on ordinary mail from the unmanned mail accepting device, and managing the ordinary mail according to the client identifier by using electronic postmark information that is displayed on the ordinary mail; and a registered mail manager for receiving electronic postmark information that is displayed on registered mail from the unmanned mail accepting device, and managing the registered mail according to the client identifier by using electronic postmark information that is displayed on the registered mail.

Yet another embodiment of the present invention provides an unmanned mail accepting method by an unmanned mail accepting device, including: measuring at least one of weight, standard, and identifier information of mail to be accepted; verifying the mail to be accepted by using a measurement result; calculating rates of the verified mail according to the weight of the mail; and displaying electronic postmark information on the mail when the client settles the rates.

Yet another embodiment of the present invention provides an unmanned mail accepting method by an unmanned mail accepting device including: measuring identifier information corresponding to an online stamp that is attached to mail; receiving issuance information of an identifier corresponding to the online stamp that is attached to the mail through communication with a mail information device; and verifying the online-stamp-attached mail by comparing the identifier information and the issuance information.

### BRIEF DESCRIPTION OF THE DRAWINGS

FIG. 1 shows an unmanned system for accepting a large amount of mail according to an exemplary embodiment of the present invention.

FIG. 2 shows a schematic diagram of an unmanned device for accepting mail according to an exemplary embodiment of the present invention.

FIG. 3 shows a schematic diagram of a data managing device according to an exemplary embodiment of the present invention.

FIG. 4 shows a schematic diagram of a mail information device according to an exemplary embodiment of the present invention.

FIG. 5 shows a flowchart of a method for accepting ordinary mail in an unmanned system for accepting a large amount of mail according to an exemplary embodiment of the present invention.

FIG. 6 shows a flowchart of a method for accepting registered mail in an unmanned system for accepting a large amount of mail according to an exemplary embodiment of the present invention.

FIG. 7 shows a flowchart of a method for verifying mail on which an online stamp is attached in an unmanned system for accepting a large amount of mail according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

An unmanned mail accepting method and device, and a data managing device according to an exemplary embodiment of the present invention will now be described in detail with reference to accompanying drawings.

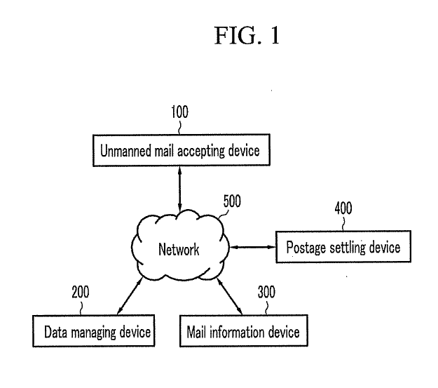

FIG. 1 shows an unmanned system for accepting a large amount of mail according to an exemplary embodiment of the present invention.

Referring to FIG. 1, the unmanned system for accepting a large amount of mail includes an unmanned mail accepting device 100, a data managing device 200, a mail information device 300, and a postage settling device 400.

The unmanned mail accepting device 100 accepts mail, and in the case of a large amount of mail, it sequentially and automatically accepts mail one by one. Therefore, in the case of a large amount of mail, the client does not need to put each piece of mail in the unmanned mail accepting device 100.

The data managing device 200 manages client information, and manages statistics on the mail. Also, the data managing device 200 provides a web site caused by management of statistics on the mail, and provides mail history on the web page by a mail reference request of the client having used the web site.

The mail information device 300 provides a web site for issuing an identifier attached to registered mail and an online stamp identifier corresponding to an online stamp, issues an identifier that is attached to registered mail and an online stamp identifier corresponding to an online stamp through the web site according to the client's request, and manages issuance information. In this instance, the identifier attached to the registered mail and the online stamp identifier corresponding to the online stamp can be barcodes or RFID codes. The identifier attached to the registered mail and the online stamp identifier corresponding to the online stamp will be assumed to be barcodes hereinafter.

The postage settling device 400 settles postage.

The unmanned mail accepting device 100, the data managing device 200, the mail information device 300, and the postage settling device 400 communicate with each other through a network 500.

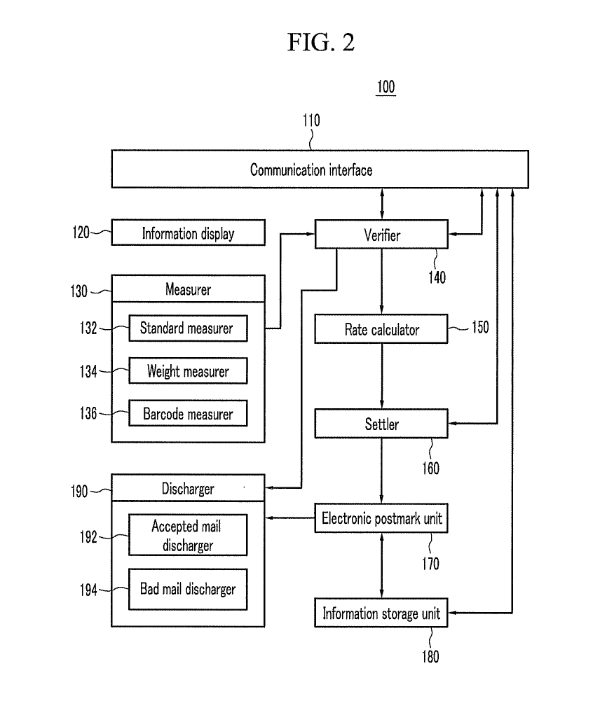

FIG. 2 shows a schematic diagram of an unmanned device for accepting mail according to an exemplary embodiment of the present invention.

Referring to FIG. 2, the unmanned mail accepting device 100 includes a communication interface 110, an information display 120, a measurer 130, a verifier 140, a rate calculator 150, a settler 160, an electronic postmark unit 170, an information storage unit 180, and discharger 190.

The communication interface 110 supports communication with the data managing device 200, the mail information device 300, and the postage settling device 400 through the network 500.

The information display 120 provides an information menu to the client and the post office manager so that the client and post office manager sending mail may select an information menu including logging-in, that is, user authentication. Here, mail includes ordinary mail and registered mail.

The measurer 130 includes a standard measurer 132, a weight measurer 134, and a barcode measurer 136. The standard measurer 132 measures the standard of the mail to be provided by the authenticated client, and the weight measurer 136 measures the weight of the mail to be provided by the authenticated client. Also, the barcode measurer 134 measures registration provisional acceptance barcode information attached to registered mail when the mail to be provided by the authenticated client is registered mail. The client who will have the registered mail accepted receives a registration provisional acceptance barcode issued by the mail information device 300, and attaches it to the registered mail before using the unmanned mail accepting device 100.

The verifier 140 verifies ordinary mail, registered mail, and online-stamp-attached mail. In detail, the verifier 140 verifies ordinary mail by using standard information measured by the standard measurer 132. The verifier 140 receives issuance information of the registration provisional acceptance barcode attached to the registered mail from the mail information device 300 through the communication interface 110, and compares issuance information and barcode information of the registered mail measured by the barcode measurer 136 to verify the registered mail. Also, the verifier 140 receives issuance information of the barcode corresponding to the online stamp from the mail information device 300 through the communication interface 110, and compares issuance information and information of the barcode measured by the barcode measurer 136 to verify the online-stamp-attached mail. Further, the verifier 140 transmits the verification result of the registered mail and the online-stamp-attached mail to the data managing device 200 through the communication interface 110. In this instance, the verifier 140 can transmit the same verification result to the mail information device 300.

The rate calculator 150 includes a rate information table for storing postage following standards and weights, and calculates the postage of the mail the standard and weight of which is measured by using the rate information table.

The settler 160 settle the postage in communication with the postage settling device 400.

The electronic postmark unit 170 displays an electronic postmark on the mail by printing part of a mail barcode and mail barcode information and a logo image on the mail when the postage is settled. The mail barcode includes at least one of post office information, client identifier ID, postmark date, mail ID, weight, and rate information.

The information storage unit 180 stores electronic postmark information displayed on the mail, and transmits electronic postmark information to the data managing device 200 through the communication interface 110. In this instance, the information storage unit 180 can transmit electronic postmark information to the mail information device 300.

The discharger 190 includes an accepted mail discharger 192 and a bad mail discharger 194. The accepted mail discharger 192 discharges electronically postmarked mail, and the bad mail discharger 194 discharges corresponding mail when the mail fails to satisfy the ordinary mail standard, the mail is unverified registered mail and online-stamp-attached mail, or the client attempts to cancel acceptance of mail. In this instance, the post office worker picks up the mail discharged by the accepted mail discharger 192, and the client again receives the mail discharged by the bad mail discharger 194.

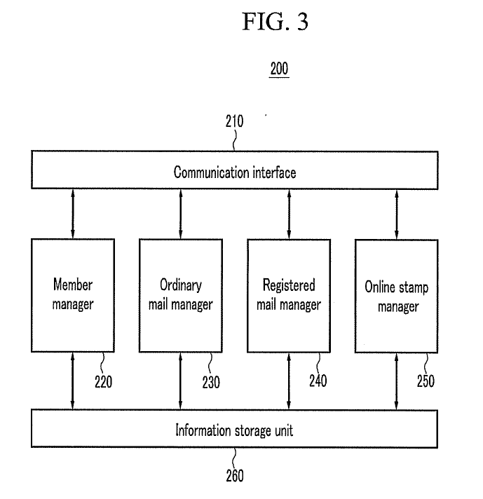

FIG. 3 shows a schematic diagram of a data managing device according to an exemplary embodiment of the present invention.

Referring to FIG. 3, the data managing device 200 includes a communication interface 210, a member manager 220, an ordinary mail manager 230, a registered mail manager 240, an online stamp manager 250, and an information storage unit 260.

The communication interface 210 supports communication with the unmanned mail accepting device 100 and the mail information device 300 through the network 500.

The member manager 220 manages client information including client ID's and passwords using the unmanned system for accepting a large amount of mail, and authenticates the client through the communication interface 210 when they log on to the system.

The ordinary mail manager 230 assigns an ordinary mail ID to the individually accepted ordinary mail, receives electronic postmark information corresponding to ordinary mail from the unmanned mail accepting device 100 through the communication interface 210, and manages ordinary mail for respective client ID's by using the electronic postmark information. Also, the ordinary mail manager 230 can transmit electronic postmark information corresponding to ordinary mail to the mail information device 300 through the communication interface 210.

The registered mail manager 240 receives electronic postmark information corresponding to registered mail from the unmanned mail accepting device 100 through the communication interface 210, and manages registered mail for respective client ID's by using electronic postmark information.

The registered mail manager 240 transmits electronic postmark information corresponding to registered mail to the mail information device 300 through the communication interface 210. Further, the registered mail manager 240 receives a verification result on registered mail from the verifier 140 of the unmanned mail accepting device 100 through the communication interface 210, stores it, and transmits the verification result to the mail information device 300 through the communication interface 210.

The online stamp manager 250 receives a verification result on the online-stamp-attached mail from the verifier 140 of the unmanned mail accepting device 100 through the communication interface 210, and stores the verification result. In addition, the online stamp manager 250 can transmit the verification result to the mail information device 300 through the communication interface 210.

The information storage unit 260 stores internal information of the data managing device 200 and information that is received through communication with the unmanned mail accepting device 100. That is, the information storage unit 260 stores client information, electronic postmark information of ordinary mail and registered mail, and verification result information on the registered mail and the online-stamp-attached mail.

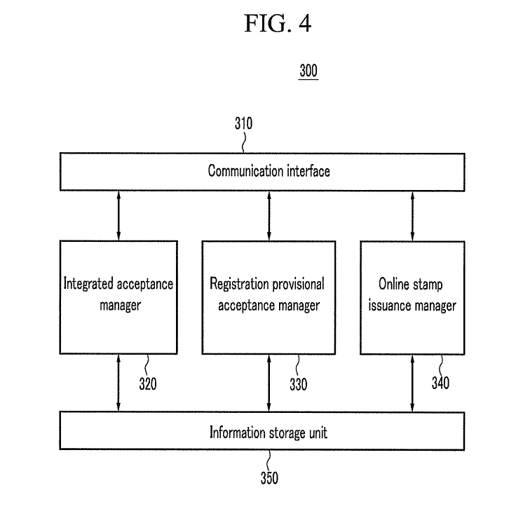

FIG. 4 shows a schematic diagram of a mail information device according to an exemplary embodiment of the present invention.

Referring to FIG. 4, the mail information device 300 includes a communication interface 310, an integrated acceptance manager 320, a registration provisional-acceptance manager 330, an online stamp issuance manager 340, and an information storage unit 350.

The communication interface 310 supports communication with the unmanned mail accepting device 100 and the data managing device 200 through the network 500.

The integrated acceptance manager 320 receives electronic postmark information of mail from the unmanned mail accepting device 100 or the data managing device 200 through the communication interface 310.

The registration provisional acceptance manager 330 authenticates the client who tries to have registered mail accepted. In this instance, the registration provisional acceptance manager 330 can authenticate the client through communication with the data managing device 200. Differing from this, the registration provisional acceptance manager 330 separately manages client information including client ID's and passwords who use the unmanned system for accepting a large amount of mail, and can authenticate the clients.

Also, the registration provisional acceptance manager 330 receives registration information from the client who will have registered mail accepted, issues a registration provisional acceptance barcode to the client based on the received registration information, and manages issuance information on the registration provisional acceptance barcode that is issued to the client. Then, the client attaches the registration provisional acceptance barcode to the registered mail, and has it accepted by using the unmanned mail accepting device 100. The registration information includes sender and recipient information.

The online stamp issuance manager 340 generally manages online stamp issuance. That is, the online stamp issuance manager 340 issues an online stamp barcode corresponding to an online stamp according to a request by the client, and manages issuance information on the online stamp barcode. The client attaches the issued online stamp barcode to the mail, and has the mail accepted. The online stamp issuance manager 340 transmits issuance information on the online stamp barcode to the unmanned mail accepting device 100 through the communication interface 310 when the unmanned mail accepting device 100 verifies the online stamp.

The information storage unit 350 stores internal information of the mail information device 300 and information that is received through communication with the unmanned mail accepting device 100 and the data managing device 200. That is, the information storage unit 350 stores issuance information of the registration provisional acceptance barcode, issuance information of the online stamp barcode, and electronic postmark information of the ordinary mail and registered mail.

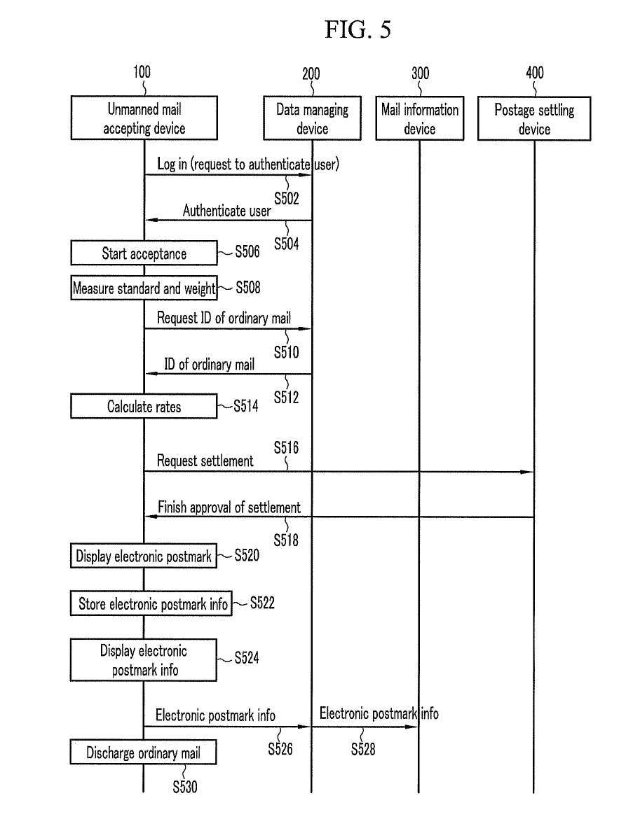

FIG. 5 shows a flowchart of a method for accepting ordinary mail in an unmanned system for accepting a large amount of mail according to an exemplary embodiment of the present invention.

Referring to FIG. 5, the client attempting to send ordinary mail inputs user information in the unmanned mail accepting device 100 to try to log on to the unmanned mail accepting device. The unmanned mail accepting device 100 requests the data managing device 200 to authenticate the user (S502). In this instance, the client who does not need to receive electronic postmark information from the data managing device 200 can select a non-member category that omits user authentication.

Upon being requested to authenticate the user from the unmanned mail accepting device 100, the data managing device 200 uses the user information input by the client to authenticate him (S504).

The client who is authenticated by the data managing device 200 uses the unmanned mail accepting device 100 to start having ordinary mail accepted (S506).

The standard and weight measurers 132 and 134 of the unmanned mail accepting device 100 measure the standard and weight of the ordinary mail provided by the client (S508). In this instance, the verifier 140 verifies ordinary mail based on the ordinary mail standard.

Regarding the verified ordinary mail, the unmanned mail accepting device 100 requests an ID of ordinary mail from the ordinary mail manager 230 of the data managing device 200 through the communication interface 110 (S510), and the ordinary mail manager 230 of the data managing device 200 transmits the ID of the ordinary mail to the unmanned mail accepting device 100 (S512).

On receiving the ID of the ordinary mail, the rate calculator 150 of the unmanned mail accepting device 100 calculates postage according to the standard and weight of ordinary mail (S514).

The settler 160 of the unmanned mail accepting device 100 requests the postage settling device 400 to settle the postage through the communication interface 110 (S516).

The postage settling device 400 approves settlement and reports completion of the approved settlement to the unmanned mail accepting device 100 (S518).

Upon receiving a report on the completion of approved settlement from the postage settling device 400, the electronic postmark unit 170 of the unmanned mail accepting device 100 prints a mail barcode and part of information on the mail barcode and a logo image to thereby display an electronic postmark on the ordinary mail (S520).

The information storage unit 170 of the unmanned mail accepting device 100 stores electronic postmark information (S522), and the information display 120 of the unmanned mail accepting device 100 displays the electronic postmark information so that the client may view it (S524).

Also, the information storage unit 170 transmits electronic postmark information to the ordinary mail manager 230 of the data managing device 200 through the communication interface 110 (S526). The ordinary mail manager 230 of the data managing device 200 sorts and manages electronic postmark information according to the client ID. In this instance, the information storage unit 170 can transmit the electronic postmark information to the integrated acceptance manager 320 of the mail information device 300 through the communication interface 110 (S528).

The accepted mail discharger 192 of the unmanned mail accepting device 100 discharges electronically postmarked ordinary mail (S530).

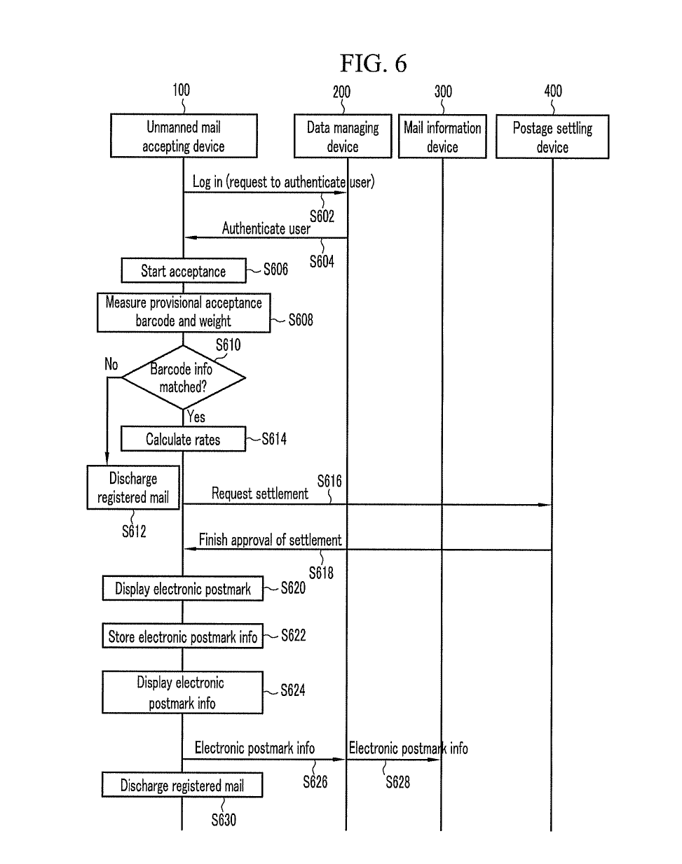

FIG. 6 shows a flowchart of a method for accepting registered mail in an unmanned system for accepting a large amount of mail according to an exemplary embodiment of the present invention.

Referring to FIG. 6, the client desiring to have registered mail accepted inputs user information in the unmanned mail accepting device 100 to attempt to log on to it. The unmanned mail accepting device 100 requests the mail information device 300 to authenticate the request (S602).

When being requested to authenticate the user from the unmanned mail accepting device 100, the mail information device 300 uses user information input by the client to authenticate the client (S604). The registration provisional acceptance manager 330 of the mail information device 300 receives registration information from the client who desires to have registered mail accepted, issues a registration provisional acceptance barcode to the client based on the received registration information, and manages issuance information of the registration provisional acceptance barcode that is issued to the client.

Therefore, when user authentication is successful, the mail information device 300 transmits registration provisional acceptance barcode information to the unmanned mail accepting device 100 through the communication interface 310.

The client that is authenticated by the mail information device 300 starts to have registered mail accepted by using the unmanned mail accepting device 100 (S606).

The weight and barcode measurers 134 and 136 of the unmanned mail accepting device 100 measure the weight and barcode information of the registered mail provided by the client (S608).

The unmanned mail accepting device 100 compares barcode information of the registered mail measured by the barcode measurer 136 and issuance information of the registration provisional acceptance barcode provided by the registration provisional acceptance manager 330 of the mail information device 300 (S610). In this instance, when the barcode information of the registered mail measured by the barcode measurer 136 does not correspond to the issuance information of the registration provisional acceptance barcode, the bad mail discharger 194 of the unmanned mail accepting device 100 discharges registered mail (S612).

On the contrary, when the barcode information of the registered mail measured by the barcode measurer 136 corresponds to the issuance information of the registration provisional acceptance barcode, the rate calculator 150 of the unmanned mail accepting device 100 calculates postage according to the weight of the registered mail (S614).

The settler 160 of the unmanned mail accepting device 100 requests the postage settling device 400 to settle the postage through the communication interface 110 (S616).

The postage settling device 400 approves the settlement, and notifies the unmanned mail accepting device 100 of completion of approved settlement (S618).

When being reported by the postage settling device 400 about the completion of approved settlement, the electronic postmark unit 170 of the unmanned mail accepting device 100 prints a mail barcode and part of information on the mail barcode and a logo image, thereby displaying an electronic postmark to the registered mail (S620).

The information storage unit 170 of the unmanned mail accepting device 100 stores electronic postmark information (S622), and the information display 120 of the unmanned mail accepting device 100 displays electronic postmark information so that the client may view it (S624).

In addition, the information storage unit 170 transmits electronic postmark information to the registered mail manager 240 of the data managing device 200 through the communication interface 110 (S626). The registered mail manager 240 of the data managing device 200 sorts and manages electronic postmark information according to the client ID. In this instance, the information storage unit 170 can transmit electronic postmark information to the integrated acceptance manager 320 of the mail information device 300 through the communication interface 110 (S628).

The accepted mail discharger 192 of the unmanned mail accepting device 100 discharges the electronically postmarked registered mail (S630).

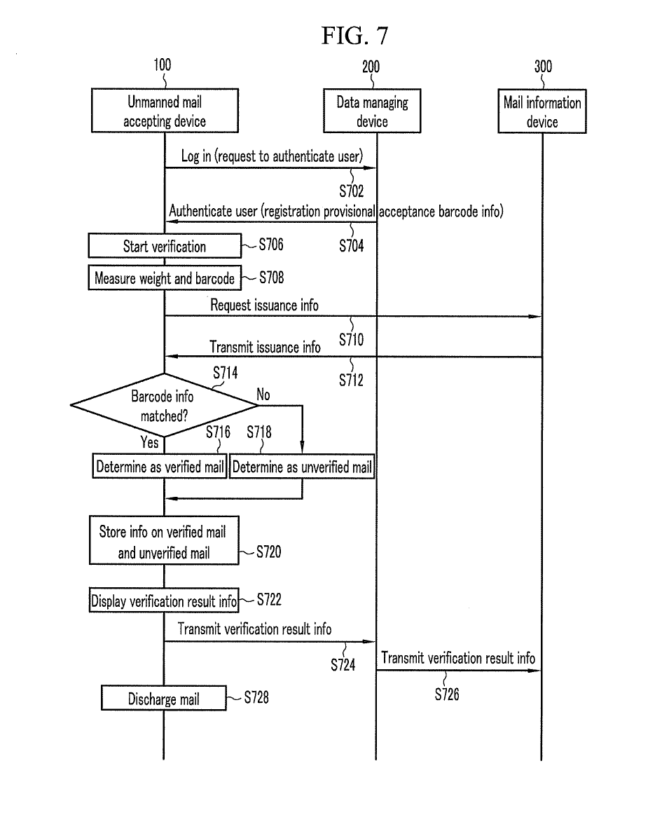

FIG. 7 shows a flowchart of a method for verifying mail on which an online stamp is attached in an unmanned system for accepting a large amount of mail according to an exemplary embodiment of the present invention.

Referring to FIG. 7, the post office attempting to verify the online-stamp-attached mail inputs user information in the unmanned mail accepting device 100 to log on to the device. The unmanned mail accepting device 100 requests the data managing device 200 to authenticate him (S702).

When requested to authenticate him from the unmanned mail accepting device 100, the data managing device 200 uses user information input by the client to authenticate him (S704).

The post office manager authenticated by the data managing device 200 uses the unmanned mail accepting device 100 to start verifying the online-stamp-attached mail (S706).

The weight and barcode measurers 134 and 136 of the unmanned mail accepting device 100 measure weight and barcode information of the mail to be verified (S708).

The verifier 140 of the unmanned mail accepting device 100 requests issuance information corresponding to the online stamp barcode from the online stamp issuance manager 340 of the mail information device 300 through the communication interface 110 (S710).

The online stamp issuance manager 340 of the mail information device 300 transmits issuance information corresponding to the online stamp barcode (S712).

The verifier 140 of the unmanned mail accepting device 100 compares the measured online stamp barcode information and issuance information that is transmitted by the online stamp issuance manager 340 of the mail information device 300 to find whether they correspond with each other (S714). In this instance, when the measured online stamp barcode information corresponds to the issuance information transmitted by the online stamp issuance manager 340 of the mail information device 300, the verifier 140 determines that the mail is verified (S716), and if not, the verifier 140 determines that the mail is unverified (S718).

The information storage unit 180 of the unmanned mail accepting device 100 stores information on the verified mail and the unverified mail (S720), and the information display 120 of the unmanned mail accepting device 100 displays verification result information so that the post office manager may view it (S722).

Further, the information storage unit 170 of the unmanned mail accepting device 100 transmits verification result information to the online stamp manager 250 of the data managing device 200 through the communication interface 110 (S724). Also, the online stamp manager 250 of the data managing device 200 transmits verification result information to the mail information device 300 (S726). Differing from this, the information storage unit 170 of the unmanned mail accepting device 100 can directly transmit the verification result information to the mail information device 300.

The unverified mail is discharged through the bad mail discharger 194 of the unmanned mail accepting device 100, and the verified mail is discharged through the accepted mail discharger 192 of the unmanned mail accepting device 100 (S728).

According to an embodiment of the present invention, since the mail acceptance process at the manned window in the post office can be removed, the post office worker's job load can be reduced, a time for the client to wait at the window for another task can be decreased, and the cost caused by loss of opportunity can be minimized. The client can quickly have mail accepted without standing by at the manned window, and can refer to the history of ordinary mail.

In addition, according to an exemplary embodiment of the present invention, it is possible to verify mail on which an online stamp is attached, thereby spreading the online stamp system.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An unmanned mail accepting device comprising:
a weight measurer for measuring at least one of weight, standard, and identifier information of mail to be accepted;
a verifier for verifying the mail to be accepted by using a measurement result of the measurer;
a rate calculator for calculate postage of the verified mail according to the weight of the mail to be accepted;
a settler for settling the postage through communication with a postage settling device; and
an electronic postmark unit for displaying electronic postmark information on the mail when the postage is settled.

2. The unmanned mail accepting device of claim 1, wherein
the measurer further includes:
a weight measurer for measuring weight of the mail to be accepted;
a standard measurer for measuring a standard of the mail to be accepted when the mail to be accepted is ordinary mail; and
a barcode measurer for measuring identifier information attached to the mail to be accepted when the mail to be accepted is registered mail or online-stamp-attached mail.

3. The unmanned mail accepting device of claim 2, wherein
the verifier receives issuance information of an identifier that is attached to the mail to be accepted through communication with a mail information device, and verifies the mail to be accepted by comparing the issuance information and the identifier information.

4. The unmanned mail accepting device of claim 1, wherein
the identifier information includes barcode information.

5. The unmanned mail accepting device of claim 1, further including:
an accepted mail discharger for discharging mail on which the electronic postmark information is displayed; and
a bad mail discharger for discharging unverified mail and mail of which acceptance will be canceled by a client.

6. The unmanned mail accepting device of claim 1, wherein
the electronic postmark information includes a mail barcode and a logo image, and
the mail barcode includes at least one of post office information, client identifier (ID), postmark date, mail ID, weight, and rate information.

7. A data managing device connected to an unmanned mail accepting device through a network, comprising:
a member manager for managing client information including a client identifier;
an ordinary mail manager for providing a mail identifier for ordinary mail provided by the client to the unmanned mail accepting device, receiving electronic postmark information that is displayed on ordinary mail from the unmanned mail accepting device, and managing the ordinary mail according to the client identifier by using electronic postmark information that is displayed on the ordinary mail; and
a registered mail manager for receiving electronic postmark information that is displayed on registered mail from the unmanned mail accepting device, and managing the registered mail according to the client identifier by using electronic postmark information that is displayed on the registered mail.

8. The data managing device of claim 7, wherein
the electronic postmark information includes a mail barcode and a logo image, and
the mail barcode includes the client identifier and the mail identifier.

9. The data managing device of claim 7, further including
an online stamp manager for receiving a verification result of online-stamp-attached mail from the unmanned mail accepting device, and managing the verification result of the mail.

10. The data managing device of claim 7, wherein
the member manager authenticates the client.

11. An unmanned mail accepting method by an unmanned mail accepting device, comprising:
measuring at least one of weight, standard, and identifier information of mail to be accepted;
verifying the mail to be accepted by using a measurement result;
calculating rates of the verified mail according to the weight of the mail; and
displaying electronic postmark information on the mail when the client settles the rates.

12. The unmanned mail accepting method of claim 11, wherein
the verifying includes:
measuring identifier information that is attached to the mail to be accepted when the mail to be accepted is registered mail;
receiving issuance information of an identifier that is attached to the mail to be accepted through communication with a mail information device; and
verifying the mail to be accepted by comparing the issuance information and the identifier information.

13. The unmanned mail accepting method of claim 11, wherein
the identifier information includes barcode information.

14. An unmanned mail accepting method by an unmanned mail accepting device, comprising:
measuring identifier information corresponding to an online stamp that is attached to mail;
receiving issuance information of an identifier corresponding to the online stamp that is attached to the mail through communication with a mail information device; and
verifying the online-stamp-attached mail by comparing the identifier information and the issuance information.

15. The unmanned mail accepting method of claim 14, wherein
the verifying includes determining the mail to be verified mail when the identifier information corresponds to the issuance information.

16. The unmanned mail accepting method of claim 14, wherein
the identifier information includes barcode information.
